(19) United States
(12) Patent Application Publication
(10) Pub. No.: US 2004/0053029 A1
(43) Pub. Date: Mar. 18, 2004

(54) Agent for protecting a material

(76) Inventors: Karsten Reihs, Koln (DE); Daniel-Gordon Duff, Leverkusen (DE); Burkhard Kohler, Leverkusen (DE); Dieter Ruhle, Odenthal (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/182,907

(22) PCT Filed: Jan. 23, 2001
(86) PCT No.: PCT/EP01/00683

(30) Foreign Application Priority Data
Feb. 4, 2000 (DE) 100 05 034.4

(51) Int. Cl. B32B 21/02; B32B 21/10

(52) U.S. Cl. 428/292.4

(57) ABSTRACT

The invention relates to an agent for protecting a material, especially a wood protection agent. The inventive agent is based on a polymer or resin, with a waterproofing agent and filler particles which are dispersed in said resin or said polymer. The invention also relates to bodies consisting of wood which have been treated with the wood protection agent and to a method for protecting materials that are sensitive to the weather, especially wood.

The invention relates to an agent for protecting materials, wooden items that have been treated with the agent for protecting materials, and a procedure for the protection of materials that are sensitive to atmospheric influences, in particular wood.

Wood is a widely used material that is, when exposed to atmospheric influences, in particular damp, susceptible to rotting which causes it to rot or become unsightly. There are numerous products for application to the wood and to act as fungicides, i.e. to kill off fungus and fungus spores or to inhibit their growth, which are designed to prevent rotting. The disadvantage of such substances, however, is that they often have undesirable effects on the bodies of humans and animals. For this reason such substances which act as fungicides are generally unsuitable in particular for the treatment of interior wood.

The task therefore is to provide an agent for the protection of materials containing no substances that preserve wood by acting as a fungicide and still preserve the wood from atmospheric influences and in particular from rotting.

The aim of the invention is an agent for the protection of materials having a hydrophobic agent and dispersed filler particles within a resin or a polymer.

The subject of the invention is an agent for the protection of materials consisting of at least one resin or polymer having hydrophobic properties or a resin or polymer containing a hydrophobic agent with filler particles within the resin or polymer.

This refers to all resins or polymers that independently form smooth films with a water contact angle of more than 100°.

The filler particles may be any kind of particle. Preferably filler particles of pyrogenically manufactured silicic acid are used, preferably with a diameter d₅₀ of 5 to 100.

Also preferred are filler particles consisting of Ni(OH)₂ particles, preferably having a mean diameter d₅₀ of 0.5 to 20 μm.

The agent for the protection of materials can be applied to materials, in particular atmospheric-resistance materials of any kind, which erode under the influence of damp. It is however preferably applied to wood.

A further subject of the invention are any items of wood, and in particular wood for external use, to which the agent according to the invention has been applied.

The coating thickness of said agent on the material to be protected is preferably from 0.05 to 200 μm.

A further subject of the invention is a method for the protection of materials that are susceptible to atmospheric conditions, particularly wood, which is distinguished in that the material is coated with said agent. Said agent may in particular be applied with a brush or sprayed on, with spraying being the preferred method of application. Spraying will preferably be repeated several times to ensure a number of coats covering one another.

Especially preferred is a method in which the filler particles and the hydrophobic agent are applied separately to the material to be protected.

Especially preferred is the method whereby the hydrophobic agent is applied to the surface of the material after the filler particles.

Suitable hydrophobic agents are all surface-active substances of all molar weights. These compounds are preferably cationic, anionic, amphoteric or non-ionic surface-active compounds as described e.g. in the directory “Surfactants Europa. A Dictionary of Surface Active Agents available in Europe, Edited by Gordon L. Hollis, Royal Society of Chemistry, Cambridge, 1995.

Particularly preferable are hydrophobic agents where 1 to 100%, and especially preferably 60 to 95% of the hydrogen atoms are substituted by fluorine atoms. For example, perfluorine alkyl sulphate, perfluorine alkyl sulphonate, perfluorine alkyl phosphate, perfluorine alkyl phosphinate and perfluorine carbonic acids.

Preferred polymeric hydrophobic agents for the [hydrophobic] coating or polymeric hydrophobic material for the surface are compounds with a molar mass M_{w}>500 to 1,000,000, preferably 1,000 to 500,000 and especially preferably 1,500 to 20,000. These polymeric hydrophobic agents may be non-ionic, anionic, cationic or amphoteric compounds. These polymer hydrophobic agents can additionally be homopolymer, copolymer, graft polymer and graft copolymer as well as static block polymers. They may additionally contain reactive groups that can react with wood, as e.g. isocyanate, epoxy or trialkoxysilane groups.

Especially preferred as polymer hydrophobic agents are those of the AB, BAB and ABC block polymer type. In the AB or BAB block polymers the A segment is a hydrophilic homopolymer or copolymer, while the B block is a hydrophobic homopolymer or copolymer or a salt thereof.

The agent for the protection of materials according to the invention enables surfaces to be effectively protected against erosion due to the influence of damp. Said agent contains no active substance that affects the human or animal body. Good protection of material is achieved even with a very thin layer of the agent. The method according to the invention is simple and economical to carry out. The person applying the agent according to the invention to, e.g., wood, does not need any respiratory protection apparatus.

All data citing average diameters refer to the numerical average.

The method according to the invention will now be described by means of one example and a comparative example, which do not, however, limit the scope of the invention.

### EXAMPLES

### Example 1

In order to coat five planks of pine wood an epoxy resin (KBD7142) was produced. To this end, a mixture consisting of 30 g glycidyl methacrylate

70 g PFMA ([C₉F₁₉CH₂CH₂O—CO—C(CH₃)═CH₂])

1 g AIBN (azobisisobutyronitrile) and

100 g MIBK (methyl isobutyl ketone)

were dripped into a flask over 2 h at 90° C. and stirred for 16 h.

Subsequently 50 g 1,1,2-trichlortrifluorethane were added.

The KBD 7142 was then dissolved 1:50 in MIBK (methyl isobutyl ketone, 100 ml) and 1 g of Aerosil R 812 (Degussa, Hanau) was added.

The said solution was then sprayed on to five pinewood planks (Pinus sylvestris Linnaeus), which treatment was repeated when the agent had dried. The quantity of material used for each application was 220 ml/m².

Exposure to atmospheric influences was carried out with reference to European Standard EN 152-1

The planks were thus placed on the flat roof of a building belonging to Bayer AG in Leverkusen and fixed at an angle of 45° C. [sic] facing a south-westerly direction. The surfaces of the planks so arranged were inoculated with the test fungi Aureobasidium pullulans (de Barry Arnaud), strain P 628 (source: Hannmünden) and Scerophoma pithyophia (Corda) v. Höhn, strain S 231 (source: Hannmünden).

Over a test period of seven months, no fungal growth was observed in all five planks.

### Comparative Example 2

Five untreated wooden planks according to Example 1 were exposed to atmospheric conditions as in Example 1. After just a few weeks the first blue patches were observed, indicating growth of blue mould.

Further Examples of Application

Coating and Weathering Exposure:

The polymer solutions described below were each sprayed on five pine planks (Pinus sylvestris Linnaeus), the treatment being repeated twice after each coat of the protective agent had dried. The amount of material used per application was approximately 200 ml/m².

Weathering exposure was carried out in accordance with European Standard EN 152-1 (cf European Standard EN 152-1:1988 “Test methods for wood preservatives: Laboratory method for determining the preventive effectiveness of a preservative treatment against blue mould”).

The planks were thus placed on the flat roof of a building belonging to Bayer AG in Leverkusen and fixed at an angle of 45° C. [sic] facing a south-westerly direction. The surfaces of the planks so arranged were inoculated with the test fungi Aureobasidium pullulans (de Barry Arnaud), strain P 628 (source: Hannmünden) and Scerophoma pithyophia (Corda) v. Höhn, strain S 231 (source: Hannmünden).

### Example 3

First of all an epoxy resin (KBD7142) was prepared. To this end a mixture consisting of

30 g glycidyl methacrylate

70 g PFMA ([C₉F₁₉CH₂CH₂O—CO—C(CH₃)═CH₂])

1 g AIBN (azobisisobutyronitrile) and

100 g MIBK (methyl isobutyl ketone)

were dripped into a flask over 2 h at 90° C. and stirred for 16 h.

Subsequently 50 g 1,1,2-trichlortrifluorethane were added.

The KBD 7142 was then dissolved 1:50 in MIBK (methyl isobutyl ketone, 100 ml) and 1 g of Aerosil R 812 (Degussa, Hanau) was added.

For testing purposes 5 pinewood planks, as described above, were coated. Over a four-month test period no fungal growth was observed on all five planks.

### Example 4

First of all a mixture consisting of:

70 g PFMA ([C₉F₁₉CH₂CH₂O—CO—C(CH₃)═CH₂])

50 mg MMA (methyl methacrylate)

1.0 g AIBN (azobisisobutyronitrile) and

100 ml butanone

were heated to 60° C. over 1 h and subsequently heated for 16 h to 70° C. under reflux.

Finally the solution was adjusted to 0.5 w- % with methylene chloride and a 0.2 g/10 g solution of spherical nickel hydroxide (type ME 01112 A1, H. C. Starck, Goslar) was added. This was then stirred for 24 h at room temperature.

For testing purposes 5 pinewood planks were coated as described above. Over a two-month test period no fungal growth was observed on all five planks.

### Example 5

A mixture consisting of

30 g trimethoxysyl propyl methacrylate

70 g PFMA ([C₉F₁₉CH₂CH₂O—CO—C(CH₃)═CH₂])

1 g azobisisobutyronitrile

1 g dodecyl mercaptan and

100 g MIBK (methyl isobutyl ketone)

were dripped into a flask over 2 h at 90° C. and stirred for 16 h.

The solution was subsequently adjusted to 2.0 w- % with methylene chloride and a 0.2 g/10 g solution of spherical nickel hydroxide (type ME 01112 A1, H. C. Starck, Goslar) was added. This was then stirred for 24 h at room temperature.

For testing purposes 5 pinewood planks were coated as described above. Over a three-month test period no fungal growth was observed on all five planks.

### Example 6

A mixture consisting of

40 g trifluromethyl styrol

60 g PFMA ([C₉F₁₉CH₂CH₂O—CO—C(CH₃)═CH₂])

100 g MIBK (methyl isobutyl ketone)

0.5 g azobisisobutyronitrile

0.5 g dodecyl mercaptan and

were dripped into a flask over 2 h at 90° C. and stirred for 16 h.

The solution was subsequently adjusted to 2.0 w- % with methylene chloride and a 0.2 g/10 g solution of spherical nickel hydroxide (type ME 01112 A1, H. C. Starck, Goslar) was added. This was then stirred for 24 h at room temperature.

For testing purposes 5 pinewood planks were coated as described above. Over a three-month test period no fungal growth was observed on all five planks.

### Example 7

100 parts of a trimerisation product of hexamethylene diisocyanate with an NCO content of 21.5% were prepared, to which were added 112.9 parts of foralkyl EOH 6N-LW (primary alcohol with a perfluorated alkyl residue; by Atochem: OHZ: 127 mg KOH/g). The reaction mixture was stirred at 75° C. until an NCO content of 5.0% was achieved. The reaction product at room temperature is a pale solid that is dissolved at 2 w- % in methylene chloride for use. Subsequently 0.2/10 g solution of Aerosil (SiO₂, type R 812, Degussa, Hanau) was added. It is finally stirred for 24 h at room temperature.

For testing purposes 5 pinewood planks were coated as described above. Over a three-month test period no fungal growth was observed on all five planks.

### Example 8

50 parts of a mixture of the dimerisation and trimerisation product of hexamethylene diisocyanate at w/w ⅔ to ⅓ with an NCO content of 21.5% were prepared, to which were added 56.5 parts of foralkyl EOH 6N-LW (by Atochem: OHZ:127 mg KOH/g). The reaction mixture was stirred at 75° C. until an NCO content of 5.0% was achieved. The reaction product at room temperature is a pale solid that is dissolved at 2 w- % in methylene chloride for use. Subsequently 0.2/10 g solution of Aerosil (SiO₂, type R 812, Degussa, Hanau) was added. It is finally stirred for 24 h at room temperature.

For testing purposes 5 pinewood planks were coated as described above. Over a two-month test period no fungal growth was observed on all five planks

### Comparative Example 9

Five non-coated wooden planks were treated as described in ‘Coating and weathering exposure’. After just a few weeks the first blue patches were observed, indicating growth of blue mould.

1. A material protecting agent consisting of at least one resin or polymer with hydrophobic properties or a resin or polymer containing a hydrophobic agent and filler particles dispersed within the resin or polymer.

2. A material protecting agent in accordance with claim 1, which is characterised in that the filler particles are pyrogenically manufactured silicic acid particles with a particle diameter d₅₀ of 5 to 100 nm.

3. A material protecting agent in accordance with claim 1, characterised in that the filler particles are Ni(OH)₂ particles with a particle diameter d₅₀ of preferably 0.5 to 20 μm.

4. A wooden item which is characterised in that it has been coated with the material protecting agent according to any one of claims 1 to 3.

5. A wooden item in accordance with claim 4 which is characterised in that the thickness of the coating of the material protecting agent is 0.05 to 200 μm.

6. A method for the protection of material that is susceptible to weathering, in particular wood, which is characterised in that said material is coated with a material protecting agent according to any of claims 1 to 3, preferably by spraying.

7. A method according to claim 6, which is characterised in that the material protecting agent is sprayed to the material several times.

8. A method according to claim 6, which is characterised in that the filler particles and the hydrophobic agents are applied separately from one another to the material.

9. A method according to claim 8, which is characterised in that the filler particles are applied to the material before the application of the hydrophobic agent.
